(19) United States
(12) Patent Application Publication
(10) Pub. No.: US 2018/0058547 A1
(43) Pub. Date: Mar. 1, 2018

(54) DUAL-CLUTCH TRANSMISSION

(71) Applicant: ZF Friedrichshafen AG, Friedrichshafen (DE)

(72) Inventors: Stefan BLATTNER, Vogt (DE); Christian MITTELBERGER, Ravensburg (DE)

(21) Appl. No.: 15/557,561

(22) PCT Filed: Feb. 19, 2016
(86) PCT No.: PCT/EP2016/053498

§ 371 Date: Sep. 12, 2017

(30) Foreign Application Priority Data
Mar. 19, 2015 (DE) 10 2015 205 043.2

(51) Int. Cl. F16H 3/00; F16H 3/097

(52) U.S. Cl. CPC F16H 3/006; F16H 2003/0826; F16H 3/097

(57) ABSTRACT

A dual-clutch transmission including first and second sub-transmissions, each having a respective input shaft. The input shafts can be coupled to a drive input shaft via a respective clutch. A transmission output shaft is common to both sub-transmissions. The input shafts are coaxial such that one shaft passing through the other which is hollow. An output shaft extends behind and is coaxial with the input shafts. To provide at least seven fully powershiftable forward gears, the two sub-transmissions together have a total of six wheel planes arranged axially, one behind another, and gearwheels which are associated with the first and second input shafts as well as the output shaft and a countershaft that extends parallel to those shafts. Depending on the shift position of seven interlocking shifting elements of the two sub-transmissions, the gearwheels of the six wheel planes transmit torque from the drive input shaft to the output shaft.

This application is a National Stage completion of PCT/EP2016/053498 filed Feb. 19, 2016, which claims priority from German patent application serial no. 10 2015 205 043.2 filed Mar. 19, 2015.

### FIELD OF THE INVENTION

The invention concerns a dual-clutch transmission.

### BACKGROUND OF THE INVENTION

DE 10 2009 020 792 A1 describes a dual-clutch transmission for the provision of ten or eleven forward gears with a geometrical progression of gear intervals between forward gears. This dual-clutch transmission has two sub-transmissions, each with a plurality of interlocking shifting elements, such that the first sub-transmission has a first transmission input shaft and the second sub-transmission has a separate, second transmission input shaft. A first frictional powershiftable clutch co-operates with the first transmission input shaft of the first sub-transmission, in such manner that when the clutch is closed it couples the first sub-transmission to a drive input shaft, whereas a second frictional powershiftable clutch co-operates with the second transmission input shaft, in such manner that when the clutch is closed it couples the second sub-transmission to the drive input shaft. A common transmission output shaft co-operates with both the sub-transmissions. In this case the second transmission input shaft is in the form of a hollow shaft which surrounds the first transmission input shaft radially and coaxially on the outside, at least in part. The transmission output shaft extends behind the first transmission input shaft and the second transmission input shaft, coaxially with the two transmission input shafts. To provide the ten or eleven forward gears the first sub-transmission and the second sub-transmission, taken together, have six or seven wheel planes arranged axially one after another, with gearwheels that mesh with one another, wherein the gearwheels of the wheel planes are associated with the first transmission input shaft, the second transmission input shaft, the transmission output shaft and a countershaft extending with its axis parallel to these. Depending on the shift position of eight or more interlocking shifting elements of the two sub-transmissions, wheel planes participate in the transfer of torque starting from the drive input shaft in the direction toward the transmission output shaft.

There is a need for a dual-clutch transmission with a simple, compact structure, which can provide at least seven fully powershiftable forward gears.

### SUMMARY OF THE INVENTION

Starting from there, the purpose of the present invention is to provide a new type of dual-clutch transmission in which, while the structure is compact, at least seven fully powershiftable forward gears can be obtained.

This objective is achieved by a dual-clutch transmission as described below. In order to provide the at least seven fully powershiftable forward gears, the first sub-transmission and the second sub-transmission have a total of six wheel planes arranged axially one behind another, with gearwheels associated with the first transmission input shaft, the second transmission input shaft, the transmission output shaft and a countershaft that extends with its axis parallel to these. The gearwheels of the six wheel planes involved in providing the forward gears participate in the transfer of torque from the drive input shaft in the direction toward the transmission output shaft, depending on the shift position of seven interlocking shifting elements of the two sub-transmissions. With the fewest possible wheel planes and shifting elements this dual-clutch transmission, whose structure is compact, can provide seven fully powershiftable forward gears.

In an advantageous further development, those gearwheels of the first and second wheel planes as seen from the drive input shaft which are associated with the second transmission input shaft, are in each case in the form of fixed wheels. The gearwheels of the first and second wheel planes associated with the countershaft are in each case loose wheels. Gearwheels of the third wheel plane as seen from the drive input shaft are so designed that a gearwheel associated with the first transmission input shaft is a fixed wheel and a gearwheel associated with the countershaft is a loose wheel. Gearwheels of the fourth wheel plane as seen from the drive input shaft are such that a gearwheel associated with the transmission output shaft and a gearwheel associated with the countershaft are in each case loose wheels. The gearwheels of the fifth and sixth wheel planes as seen from the drive input shaft which are associated with the transmission output shaft are, according to a first variant, in each case loose wheels or according to a second variant they are fixed wheels, so that the gearwheels of the fifth and sixth wheel planes associated with the countershaft are each fixed wheels according to the first variant or loose wheels according to the second variant. With as few wheel planes as possible, seven fully powershiftable forward gears can be provided.

Preferably, those gearwheels of the first and second wheel planes associated with the second transmission input shaft which are in the form of fixed wheels, are solidly coupled with one another. The gearwheels associated with the countershaft and in the form of loose wheels of the third wheel plane and fourth wheel plane are also solidly coupled with one another. Furthermore, the gearwheels of the fifth and sixth wheel planes associated with the countershaft and made as fixed wheels in accordance with the first variant, or the gearwheels of the fifth and sixth wheel planes associated with the transmission output shaft and made as fixed wheels in accordance with the second variant, are solidly coupled with one another. With as few wheel planes as possible seven fully powershiftable forward gears can be provided.

In another advantageous further development, with the gearwheels of the first and second wheel planes associated with the countershaft there are associated two interlocking shifting elements, namely in such manner that when a first shifting element of these two shifting elements is closed, the gearwheel of the first wheel plane associated with the countershaft and made as a loose wheel is coupled to the countershaft, whereas when a second shifting element of these two shifting elements is closed, the gearwheel of the second wheel plane associated with the countershaft and made as a loose wheel is coupled to the countershaft. Associated with the gearwheels of the third and fourth wheel planes assigned to the first transmission input shaft and the transmission output shaft there are two further interlocking shifting elements, namely in such manner that when a first shifting element of these two shifting elements is closed, the gearwheel of the third wheel plane associated with the first transmission input shaft and made as a fixed wheel is coupled to the transmission output shaft, whereas in contrast, when a second shifting element of these two shifting elements is closed, the gearwheel of the fourth wheel plane associated with the transmission output shaft and made as a loose wheel is coupled to the transmission output shaft. Associated with the gearwheels of the third and fourth wheel planes assigned to the countershaft there is a further shifting element, namely in such manner that when it is closed the gearwheels of the third and fourth wheel planes associated with the countershaft and made in the form of loose wheels are both coupled to the countershaft. According to the first variant the gearwheels of the fifth and sixth wheel planes associated with the transmission output shaft, or according to the second variant the gearwheels of the fifth and sixth wheel planes associated with the countershaft, have associated with them two further interlocking shifting elements, namely in such manner that depending on which of these shifting elements is closed, the respective gearwheel of the fifth wheel plane or of the sixth wheel plane that is made as a loose wheel is functionally connected to the transmission output shaft. With as few interlocking shifting elements as possible, seven fully powershiftable forward gears can be provided.

Preferably, the two shifting elements associated with the first and second wheel planes are in the form of a double shifting element, as also are the shifting elements associated with the third and fourth wheel planes and those associated with the fifth and sixth wheel planes. This is advantageous for the provision of a compact structure of the dual-clutch transmission.

Preferably, the two shifting elements associated with the first wheel plane and the second wheel plane are positioned between the first and second wheel planes. The two shifting elements associated with the third and fourth wheel planes, which co-operate with the gearwheels of these wheel planes assigned to the first transmission input shaft and the transmission output shaft, are positioned between the third wheel plane and the fourth wheel plane. The shifting element associated with the third and fourth wheel planes, which co-operates with the gearwheels of these wheel planes that are assigned to the countershaft, is positioned between the fourth wheel plane and the fifth wheel plane. The two shifting elements associated with the fifth wheel plane and the sixth wheel plane are positioned between the fifth and sixth wheel planes. This too is advantageous for the provision of a compact structure of the dual-clutch transmission.

The fifth wheel plane and the sixth wheel plane can be interchanged.

### BRIEF DESCRIPTION OF THE DRAWINGS

Preferred further developments emerge from the claims and the following description. Example embodiments of the invention, to which it is not limited, are described in greater detail with reference to the drawings, which show:

FIG. 1: A schematic representation of a first dual-clutch transmission according to the invention;

FIG. 2: A schematic representation of a second dual-clutch transmission according to the invention;

FIG. 3: A shifting matrix for the dual-clutch transmission shown in FIG. 2.

### DETAILED DESCRIPTION OF THE PREFERRED EMBODIMENTS

The present invention concerns a dual-clutch transmission.

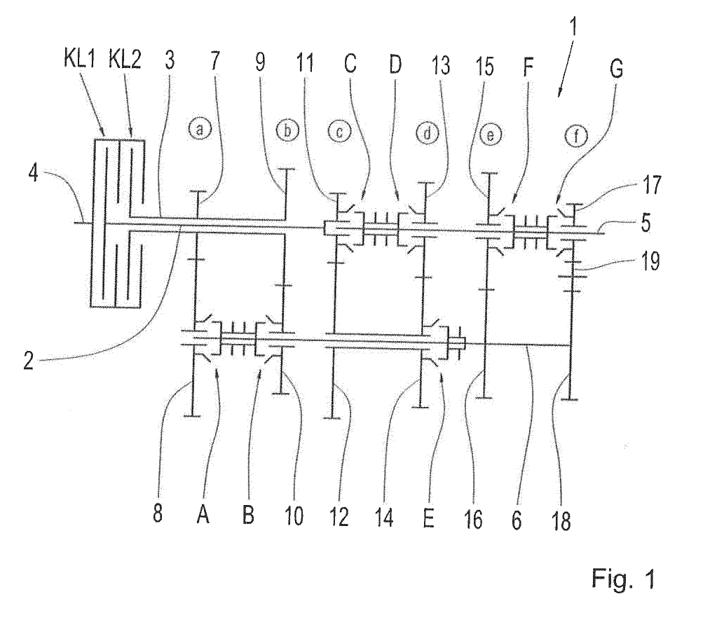

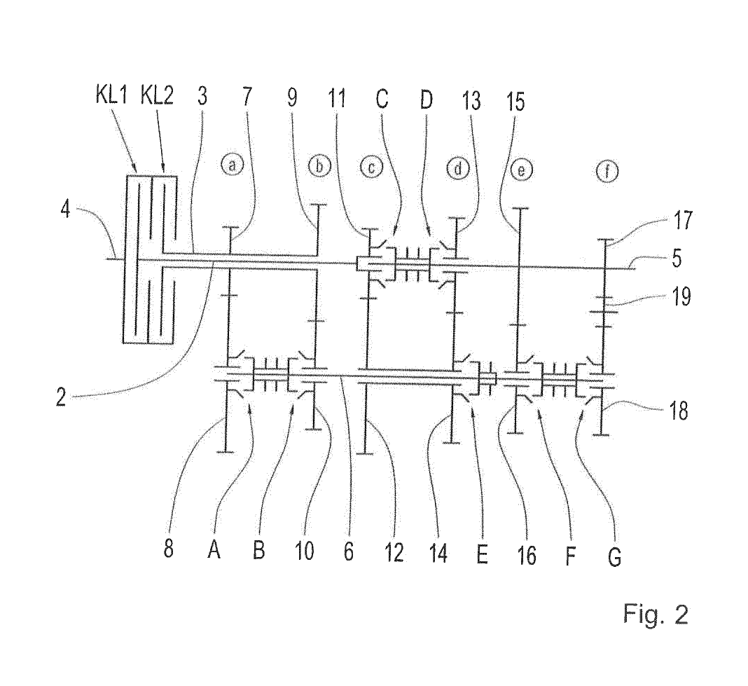

FIGS. 1 and 2 show, respectively, details of two embodiment variants of a dual-clutch transmission 1 according to the invention.

The dual-clutch transmission 1 has two sub-transmissions, wherein a first transmission input shaft 2 co-operates with a first sub-transmission and a second, separate transmission input shaft 3 co-operates with a second sub-transmission. Associated with the two transmission input shafts 2, 3 are respective frictional powershiftable clutches KL1 and KL2. When the first frictional powershiftable clutch KL1 is closed, the first transmission input shaft 2 and hence the first sub-transmission of the dual-clutch transmission 1 is coupled to a drive input shaft 4. When the second frictional powershiftable clutch KL2 is closed, the second transmission input shaft 3 and hence the second sub-transmission of the dual-clutch transmission 1 is coupled to the drive input shaft 4. Either the first frictional powershiftable clutch KL1 or the second powershiftable clutch KL2 is closed, so that in all cases only one of the two sub-transmissions is coupled to the drive input shaft 4 by way of the respective transmission input shaft 2 or 3.

A common transmission output shaft 5 co-operates with both of the sub-transmissions. According to FIG. 1 the two input shafts 2 and 3 and the transmission output shaft 5 are arranged coaxially with one another. In this case the second transmission input shaft 3 is in the form of a hollow shaft, which in part surrounds the first transmission input shaft 2, preferably made as a solid shaft, radially and coaxially on the outside. Like the first transmission input shaft 2, so too the transmission output shaft 5 is preferably a solid shaft extending coaxially behind the two transmission input shafts 2 and 3.

For the provision of seven fully powershiftable forward gears the dual-clutch transmission 1 has six wheel planes a, b, c, d, e and f with gearwheels 7, 8, 9, 10, 11, 12, 13, 14, 15, 16, 17, 18 and 19 that mesh with one another, and seven interlocking shifting elements A, B, C, D, E, F, and G. The six wheel planes a, b, c, d, e and f are arranged axially one behind another. The gearwheels 7, 8, 9, 10, 11, 12, 13, 14, 15, 16, 17, 18 and 19 are associated with the first transmission input shaft 2, the second transmission input shaft 3, the transmission output shaft 5 and a countershaft 6 that extends axis-parallel to these. Depending on the shift positions of the seven interlocking shifting elements A, B, C, D, E, F, G of the two sub-transmissions, the gearwheels 7, 8, 9, 10, 11, 12, 13, 14, 15, 16, 17, 18 and 19 of the six wheel planes a, b, c, d, e and f participate in the transmission of torque from the drive input shaft 4 in the direction toward the transmission output shaft 5.

The gearwheels 7, 9, which are associated with the second transmission input shaft 3, of the first wheel plane a as seen from the drive input shaft 4, which wheel plane is the smallest distance away from the drive input shaft 4, and of the second wheel plane b as seen from the drive input shaft 4, which wheel plane is the second-smallest distance away from the drive input shaft 4, are in each case made as fixed wheels.

In contrast, the gearwheels 8, 10 of the first and second wheel planes a, b as seen from the drive input shaft 4, which gearwheels are associated with the countershaft 6, are each loose wheels.

Gearwheels 11, 12 of the third wheel plane c as seen from the drive input shaft 4, which is the wheel plane with the third-smallest distance from the drive input shaft 4, are so designed that a gearwheel 11 associated with the first transmission input shaft 2 is a fixed wheel and a gearwheel 12 associated with the countershaft 6 is a loose wheel.

Gearwheels 13, 14 of the fourth wheel plane d as seen from the drive input shaft 4, which is the wheel plane with the third-largest distance from the drive input shaft 4, are designed such that a gearwheel 13 associated with the transmission output shaft 5 and a gearwheel 14 associated with the countershaft 6 are both loose wheels.

The gearwheels 15, 17, of the fifth wheel plane e as seen form the drive input shaft 4, which is the second-largest distance away from the drive input shaft 4, and of the sixth wheel plane f which is the largest distance away from the drive input shaft 4 are associated with the transmission output shaft 5 and are according to a first variant (see FIG. 1) each made as loose wheels, or according to a second variant (see FIG. 2) each made as fixed wheels. The gearwheels 16, 18 of the fifth and sixth wheel planes e, f as seen from the drive input shaft 4, are each made as fixed wheels according to the first variant (see FIG. 1) or each made as loose wheels according to the second variant (see FIG. 2).

The gearwheels 7, 9 of the first and second wheel planes a, b, which are associated with the second transmission input shaft 3, are coupled solidly to one another. Moreover the gearwheels 12, 14 of the third and fourth wheel planes c, d, which are associated with the countershaft 6, are coupled solidly to one another. According to the first variant (see FIG. 1) the gearwheels 16, 18 of the fifth and sixth wheel planes e, f associated with the countershaft 6, and according to the second variant (see FIG. 2) the gearwheels 15, 17 of fifth and sixth wheel planes e, f associated with the transmission output shaft 5, each of them made as a fixed wheel, are respectively coupled solidly to one another.

Associated with the gearwheels 8, 10 of the first and second wheel planes a. b, which gearwheels are assigned to the countershaft 6, there are two interlocking shifting elements A, B, namely in such manner that when a first shifting element A of these shifting elements A, B is closed, the gearwheel 8 of the first wheel plane a made as a loose wheel and associated with the countershaft 6 is coupled to the countershaft 6, whereas when a second shifting element B of these shifting elements A, B is closed, the gearwheel 10 of the second wheel plane b made as a loose wheel and associated with the countershaft 6 is coupled to the countershaft 6. These shifting elements A and B associated with the first wheel plane a and the second wheel plane b are preferably in the form of a double shifting element such that at any time only one of these shifting elements A, B is closed. These two shifting elements A, B associated with the first and second wheel planes a, b are preferably positioned between first wheel plane a and second wheel plane b.

Associated with the gearwheels 11, 13 of the third and fourth wheel planes c, d assigned to the first transmission input shaft 2 and the transmission output shaft 5, there are two further interlocking shifting elements C, D, namely in such manner that when a first one C of these shifting elements C, D is closed, the gearwheel 11 of the third wheel plane c, made as a fixed wheel and associated with the first transmission input shaft 2, is coupled to the transmission output shaft 5, whereas when a second one D of these shifting elements C, D is closed, the gearwheel 13 of the fourth wheel plane d, made as a loose wheel and associated with the transmission output shaft 5, is coupled to the transmission output shaft 5. When the first shifting element C of these shifting elements C, D is closed, the first transmission input shaft 2 and the transmission output shaft 5 are coupled directly and immediately with one another. These two shifting elements C, D associated with the third wheel plane c and the fourth wheel plane d are preferably made as a double shifting element such that at any time only one of these shifting elements C, D is closed. These two shifting elements C, D associated with the third and fourth wheel planes c, d, which co-operate with the gearwheels 11, 13 of wheel planes assigned to the first transmission input shaft 2 and the transmission output shaft 5, are preferably positioned between the third wheel plane c and the fourth wheel plane d.

Associated with the gearwheels 12, 14 of the third and fourth wheel planes c, d, which gearwheels are assigned to the countershaft 6, there is a further interlocking shifting element E such that when it is closed the gearwheels 12, 14 of the third and fourth wheel planes c, d, made as loose wheels, are both coupled to the countershaft 6. This shifting element E associated with the third wheel plane c and the fourth wheel plane d, which co-operates with the gearwheels 12, 14 of wheel planes associated with the countershaft 6, is preferably positioned between the fourth wheel plane d and the fifth wheel plane e.

According to the first variant (see FIG. 1) the gearwheels 15, 17 of the fifth and sixth wheel planes e, f, which gearwheels are associated with the transmission output shaft 5, or according to the second variant (see FIG. 2) the gearwheels 16, 18 of the fifth and sixth wheel planes e, f, which are associated with the countershaft 6, have assigned to them two further interlocking shifting elements F, G, namely in such manner that depending on which of these shifting elements F, G is closed, the respective gearwheel 15, 16 of the fifth wheel plane e made as a loose wheel, or of the sixth wheel plane f made as a loose wheel is in functional connection with the transmission output shaft 5. These two shifting elements F, G associated with the fifth wheel plane e and the sixth wheel plane f are preferably made in the form of a double shifting element, in such manner that at any time only one of shifting elements F, G is closed. two shifting elements F, G, which according to the first variant (see FIG. 1) co-operate with the gearwheels 15, 17 of these wheel planes associated with the transmission output shaft 5 or, according to the second variant (see FIG. 2) co-operate with the gearwheels 16, 18 of these wheel planes associated with the countershaft 6, are preferably positioned between the fifth wheel plane e and the sixth wheel plane f.

The gearwheels 7, 8 of the first wheel plane a and the gearwheels 9, 10 of the second wheel plane b and the gearwheels 11, 12 of the third wheel plane c and the gearwheels of the fourth wheel plane d and the gearwheels 15, 16 of the fifth wheel plane e, which are associated either with the transmission input shafts 2, 3 or with the transmission output shaft 5 or with the countershaft 6, mesh directly with one another. The gearwheels 17, 18 of the sixth wheel plane f, which are associated with the transmission output shaft 5 or with the countershaft 6, mesh indirectly with one another with the interposition of a further gearwheel 19.

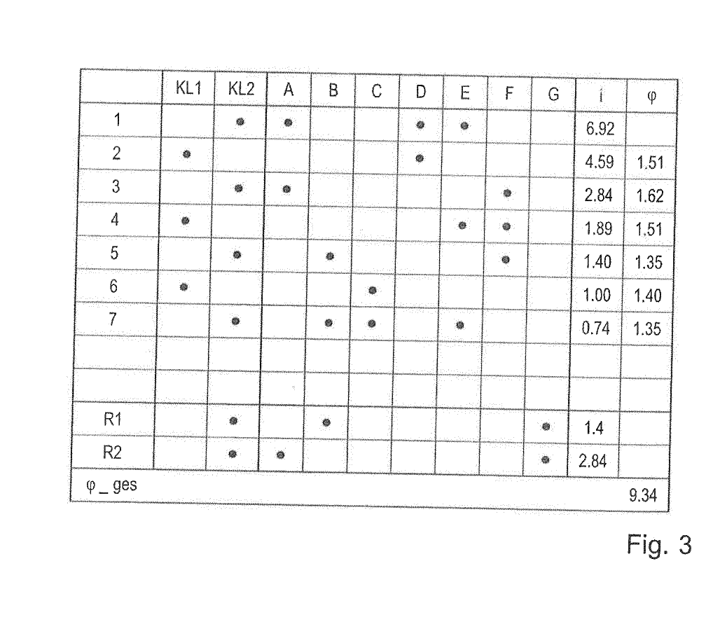

With the fewest possible wheel planes and shifting elements the dual-clutch transmission is of compact form and can provide seven fully powershiftable forward gears “1” to “7” (see the shifting matrix in FIG. 3). In the shifting matrix of FIG. 3 the shifting elements which are closed in the respective forward gears “1” to “7” are indicated by a dot. Furthermore, FIG. 3 indicates clearly advantageous gear ratios i and advantageous gear intervals φ.

As can be seen from the shifting matrix in FIG. 3, two reversing gears “R1” and “R2” can also be obtained. In the reversing gears “R1” and “R2” the shifting element G is closed in each case.

In forward gear “1” the powershiftable clutch KL2 and the interlocking shifting elements A, D, E are closed. The wheel planes a and d then participate in the torque transmission.

In forward gear “2” the powershiftable clutch KL1 and the interlocking shifting element D are closed. The wheel planes c and d then participate in the torque transmission.

In forward gear “3” the powershiftable clutch KL2 and the interlocking shifting elements A, F are closed. The wheel planes a and e then participate in the torque transmission.

In forward gear “4” the powershiftable clutch KL1 and the interlocking shifting elements E, F are closed. The wheel planes c and e then participate in the torque transmission.

In forward gear “5” the powershiftable clutch KL2 and the interlocking shifting elements B, F are closed. The wheel planes b and e then participate in the torque transmission.

In forward gear “6” the powershiftable clutch KL1 and the interlocking shifting element C are closed. This is a direct gear.

In forward gear “7” the powershiftable clutch KL2 and the interlocking shifting elements B, C, E are closed. The wheel planes b, d, c then participate in the torque transmission.

These seven forward gears are fully powershiftable.

### INDEXES

1 Dual-clutch transmission
2 Transmission input shaft
3 Transmission input shaft
4 Drive input shaft
5 Transmission output shaft
6 Countershaft
7 Gearwheel
8 Gearwheel
9 Gearwheel
10 Gearwheel
11 Gearwheel
12 Gearwheel
13 Gearwheel
14 Gearwheel
15 Gearwheel
16 Gearwheel
17 Gearwheel
18 Gearwheel
19 Gearwheel
a Wheel plane
b Wheel plane
c Wheel plane
d Wheel plane
e Wheel plane
f Wheel plane
KL1 Powershiftable clutch
KL2 Powershiftable clutch
A Shifting element
B Shifting element
C Shifting element
D Shifting element
E Shifting element
F Shifting element
G Shifting element

1-9. (canceled)

10. A dual-clutch transmission (1) for providing at least seven forward gears, the transmission comprising:
a first sub-transmission;
a second sub-transmission;
a first transmission input shaft (2) for the first sub-transmission and a separate, second transmission input shaft (3) for the second sub-transmission;
a first frictional, powershiftable clutch (KL1) being associated with the first transmission input shaft (2) which, when the first clutch is engaged, coupling the first transmission input shaft (2) and also the first sub-transmission to a drive input shaft (4);
a second frictional, powershiftable clutch (KL2) being associated with the second transmission input shaft (3) which, when the second clutch is engaged, coupling the second transmission input shaft (3) and also the second sub-transmission to the drive input shaft (4);
a transmission output shaft (5) being common to both the first and the second sub-transmissions;
the second transmission input shaft (3) being a hollow shaft which partially radially surrounds the first transmission input shaft (2), and the first and the second transmission input shafts being coaxial with one another;
the transmission output shaft (5) extending behind and coaxially with the first and the second transmission input shafts (2, 3);
the first sub-transmission and the second sub-transmission together, for provision of at least seven fully powershiftable forward gears, have a total of first, second, third, fourth, fifth and sixth wheel planes (a, b, c, d, e, f) arranged one behind another with gearwheels (7, 8, 9, 10, 11, 12, 13, 14, 15, 16, 17, 18, 19) associated with the first transmission input shaft (2), the second transmission input shaft (3), the transmission output shaft (5) and a countershaft (6) having an axis that extends parallel to the first and the second transmission input shafts and the transmission output shaft; and
depending on shift positions of seven interlocking shifting elements (A, B, C, D, E, F, G) of the first and the second sub-transmissions, the gearwheels (7, 8, 9, 10, 11, 12, 13, 14, 15, 16, 17, 18, 19) of the six wheel planes (a, b, c, d, e, f) participate in transmission of torque from the drive input shaft (4) in a direction of the transmission output shaft (5).

11. The dual-clutch transmission according to claim 10, wherein
the gearwheels (7, 9) of the first and second wheel planes (a, b) which are associated with the second transmission input shaft (3), as seen from the drive input shaft (4), are each fixed wheels;
the gearwheels (8, 10) of the first and the second wheel planes (a, b) which are associated with the countershaft (6), as seen from the drive input shaft (4), are each loose wheels;
the gearwheels (11, 12) of the third wheel plane (c), as seen from the drive input shaft (4), are such that a gearwheel (11) associated with the first transmission input shaft (2) is a fixed wheel and a gearwheel (12) associated with the countershaft (6) is a loose wheel;
the gearwheels (13, 14) of the fourth wheel plane (d), as seen from the drive input shaft (4), are such that a gearwheel (13) associated with the transmission output shaft (5) and a gearwheel (14) associated with the countershaft (6) are both loose wheels;
the gearwheels (15, 17) of the fifth and the sixth wheel planes (e, f) which are associated with the transmission output shaft (5), as seen from the drive input shaft (4), are either both loose wheels, according to a first variant, or both fixed wheels, according to a second variant;
the gearwheels (16, 18) of the fifth and the sixth wheel planes (e, f) which are associated with the countershaft (6), as seen from the drive input shaft (4), are either both fixed wheels, according to the first variant, or both loose wheels, according to the second variant.

12. The dual-clutch transmission according to claim 11, wherein
the gearwheels (7, 9) of the first and the second wheel planes (a, b) associated with the second transmission input shaft (3), which are fixed wheels, are solidly coupled with one another;
the gearwheels (12, 14) of the third and the fourth wheel planes (c, d) associated with the countershaft (6), which are loose wheels, are solidly coupled with one another;
the gearwheels of the fifth wheel plane (e) and the sixth wheel plane (f) associated with the countershaft (6), according to the first variant, and associated with the transmission output shaft (5), according to the second variant, which are all fixed wheels (16, 18; 15, 17), are solidly coupled to one another.

13. The dual-clutch transmission according to claim 11, wherein
two interlocking shifting elements (A, B) are associated with the gearwheels (8, 10) of the first and the second wheel planes (a, b), which gearwheels are associated with the countershaft (6), in such manner that when a first shifting element (A) of these interlocking shifting elements (A, B) is engaged, the gearwheel (8) of the first wheel plane (a) associated with the countershaft (6) and made as a loose wheel is coupled to the countershaft (6), and when a second shifting element (B) of these interlocking shifting elements (A, B) is engaged, the gearwheel (10) of the second wheel plane (b) associated with the countershaft (6) and made as a loose wheel is coupled to the countershaft (6);
two further interlocking shifting elements (C, D) are associated with the gearwheels (11, 13) of the third and the fourth wheel planes (c, d), which gearwheels are associated with the first transmission input shaft (2) and the transmission output shaft (5), in such manner that when a first shifting element (C) of these further interlocking shifting elements (C, D) is engaged, the gearwheel (11) of the third wheel plane (c) associated with the first transmission input shaft (2) and made as a fixed wheel is coupled to the transmission output shaft (5), and when a second shifting element (D) of the further interlocking shifting elements (C, D) is engaged, the gearwheel (13) of the fourth wheel plane (d) associated with the transmission output shaft (5) and made as a loose wheel is coupled to the transmission output shaft (5);
an other interlocking shifting element (E) is associated with the gearwheels (12, 14) of the third and the fourth wheel planes (c, d), which gearwheels are assigned to the countershaft (6), in such manner that when the other interlocking shifting element is engaged, the gearwheels (12, 14) of the third and the fourth wheel planes (c, d), which gearwheels are associated with the countershaft (6), are both coupled to the countershaft (6);
two additional interlocking shifting elements (F, G) are associated with either the gearwheels (15, 17) of the fifth and the sixth wheel planes (e, f), which are loose wheels and are assigned to the transmission output shaft (5), according to the first variant, or the gearwheels (16, 18) of the fifth and the sixth wheel planes (e, f), which are loose wheels and are assigned to the countershaft (6) such that, depending on which of the additional interlocking shifting elements (F, G) is engaged, the respective gearwheel (15, 16) of the fifth wheel plane (e) or of the sixth wheel plane (f) which is made as a loose wheel, is in functional connection with the transmission output shaft (5).

14. The dual-clutch transmission according to claim 13, wherein
the two interlocking shifting elements (A, B) associated with the first wheel plane (a) and the second wheel plane (b), which co-operate with the gearwheels (8, 10) of those wheel planes which are associated with the countershaft (6), are in a form of a double shifting element such that at any time only one of the two interlocking shifting elements (A, B) is engaged;
the two further interlocking shifting elements (C, D) associated with the third wheel plane (c) and the fourth wheel plane (d), which co-operate with the gearwheels (11, 13) of those wheel planes which are associated with the first transmission input shaft (2) and the transmission output shaft (5), are in a form of a double shifting element such that at any time only one of the two further interlocking shifting elements (C, D) is engaged;
the two additional interlocking shifting elements (F, G) associated with the fifth wheel plane (e) and the sixth wheel plane (f), which according to the first variant co-operate with the gearwheels (15, 17) of those wheel planes which are associated with the transmission output shaft (5), or according to the second variant co-operate with the gearwheels (16, 18) of the those wheel planes which are associated with the countershaft (6), are in a form of a double shifting element such that at any time only one of the two additional interlocking shifting elements (F, G) is engaged.

15. The dual-clutch transmission according to claim 13, wherein
the two interlocking shifting elements associated with the first wheel plane (a) and the second wheel plane (b), which co-operate with the gearwheels (8, 10) of these wheel planes which are associated with the countershaft (6), are positioned between the first wheel plane (a) and the second wheel plane (b);
the two further interlocking shifting elements (C, D) associated with the third wheel plane (c) and the fourth wheel plane (d), which co-operate with the gearwheels (11, 13) of these wheel planes which are associated with the first transmission input shaft (2) and the transmission output shaft (5), are positioned between the third wheel plane (c) and the fourth wheel plane (d);
the other interlocking shifting element (E) associated with the third wheel plane (c) and the fourth wheel plane (d), which co-operates with the gearwheels (12, 14) of these wheel planes which are associated with the countershaft (6), is positioned between the fourth wheel plane (d) and the fifth wheel plane (e);
the two additional interlocking shifting elements (F, G) associated with the fifth wheel plane (e) and the sixth wheel plane (f) which, according to the first variant, co-operate with the gearwheels of these wheel planes which are associated with the transmission output shaft (5) or, according to the second variant, co-operate with the gearwheels (16, 18) of these wheel planes which are associated with the countershaft (6), are positioned between the fifth wheel plane (e) and the sixth wheel plane (f).

16. The dual-clutch transmission according to claim 11, wherein the gearwheels (7, 8) of the first wheel plane (a) and the gearwheels (9, 10) of the second wheel plane (b) and the gearwheels (11, 12) of the third wheel plane (c) and the gearwheels (13, 14) of the fourth wheel plane (d) and the gearwheels (15, 16) of the fifth wheel plane (e), which are associated either with the transmission input shafts (2, 3) or with the transmission output shaft (5), directly mesh with one another.

17. The dual-clutch transmission according to claim 11, wherein the gearwheels (17, 18) of the sixth wheel plane (f), which are associated with the transmission output shaft (5) or the countershaft (6), indirectly mesh with one another with interposition of a further gearwheel (19).

18. The dual-clutch transmission according to claim 10, wherein the fifth wheel plane (e) and the sixth wheel plane (f) are interchanged.

19. A dual-clutch transmission providing at least seven forward gears, the transmission comprising:
a first sub-transmission having a first transmission input shaft and a second sub-transmission having a second transmission input shaft that is hollow;
the first and the second transmission input shafts being coaxially aligned, and the first transmission input shaft extending axially through the second transmission input shaft;
a first frictional, powershiftable clutch being engagable for coupling the first transmission input shaft with a drive input shaft;
a second frictional, powershiftable clutch being engagable for coupling the second transmission input shaft with the drive input shaft;
a transmission output shaft being common to both of the first and the second sub-transmissions and extending behind and coaxially with the first and the second transmission input shafts;
a countershaft extending parallel to the first and the second transmission input shafts and the transmission output shaft;
first, second, third, fourth, fifth, sixth, seventh, eighth, ninth, tenth, eleventh and twelfth gearwheels being supported by the first and the second transmission input shafts, the transmission output shaft and the countershaft, and the gearwheels forming first, second, third, fourth, fifth and sixth wheel planes which are axially arranged, from an input side of the transmission to an output side of the transmission, in an order of: the first wheel plane, the second wheel plane, the third wheel plane, the fourth wheel plane, the fifth wheel plane and the sixth wheel plane; and
first, second, third, fourth, fifth, sixth and seventh interlocking shifting elements of the first and the second sub-transmissions and the first and the second clutches being selectively engagable for transmitting torque from the drive input shaft to the transmission output shaft and implementing at least seven fully powershiftable forward gears.

20. The dual-clutch transmission according to claim 19, wherein
the first wheel plane comprises the first gearwheel, which is a fixed wheel continually connected to the second transmission input shaft, and the second gearwheel which is a loose wheel supported on the countershaft;
the second wheel plane comprises the third gearwheel, which is a fixed wheel continually connected to the second transmission input shaft, and the fourth gearwheel which is a loose wheel supported on the countershaft;
the third wheel plane comprises the fifth gearwheel, which is a fixed wheel continually connected to the first transmission input shaft, and the sixth gearwheel which is a loose wheel supported on the countershaft;
the fourth wheel plane comprises the seventh gearwheel, which is a loose wheel supported on the transmission output shaft, and the eighth gearwheel which is a loose wheel supported on the countershaft; and
the fifth wheel plane comprises the ninth and the tenth gearwheels and the sixth wheel plane comprises the eleventh and the twelfth gearwheels, the ninth and the eleventh gearwheels are fixed wheels continually connected in common to a first one of the transmission output shaft and the countershaft, and the tenth and the twelfth gearwheels are loose wheels supported in common by a second one of the transmission output shaft and the countershaft.

21. The dual-clutch transmission according to claim 20, wherein the sixth gearwheel is continually connected to the eighth gearwheel for preventing relative rotation between the sixth and the eighth gearwheels.

22. The dual-clutch transmission according to claim 21, wherein
the first and the second interlocking shifting elements are axially arranged between the first and the second wheel planes, the first interlocking shifting element is engagable to couple the second gearwheel to the countershaft, and the second interlocking shifting element is engagable to couple the fourth gearwheel to the countershaft;
the third and the fourth interlocking shifting elements are axially arranged between the third and the fourth wheel planes, the third interlocking shifting element is engagable for coupling the fifth gearwheel to the transmission output shaft, and the fourth interlocking shifting element is engagable for coupling the seventh gearwheel to the transmission output shaft;
the fifth interlocking shifting element is axially arranged between the fourth and the fifth wheel planes and is engagable for coupling the eighth gearwheel to the countershaft; and
the sixth and the seventh interlocking shifting elements are axially arranged between the fifth and the sixth gear planes, the sixth interlocking shifting element is engagable for coupling the tenth gearwheel to the second one of the transmission output shaft and the countershaft, and the seventh interlocking shifting element is engagable for coupling the twelfth gearwheel to the second one of the transmission output shaft and the countershaft.

23. The dual-clutch transmission according to claim 20, wherein
the first and the second gearwheels directly mesh with one another;
the third and the fourth gearwheels directly mesh with one another;
the fifth and the sixth gearwheels directly mesh with one another;
the seventh and the eighth gearwheels directly mesh with one another;
the ninth and the tenth gearwheels directly mesh with one another; and
the eleventh and the twelfth gearwheels mesh directly mesh with a further gearwheel that is interposed therebetween to facilitate implementing at least to reverse gears.
